(19) United States
(12) Patent Application Publication
(10) Pub. No.: US 2015/0316653 A1
(43) Pub. Date: Nov. 5, 2015

(54) DEVICE FOR DETERMINING THE LOCATION OF A VEHICLE

(71) Applicant: Continental Teves AG & Co. oHG, Frankfurt (DE)

(72) Inventor: Ulrich Stählin, Eschborn (DE)

(21) Appl. No.: 14/650,408

(22) PCT Filed: Dec. 11, 2013
(86) PCT No.: PCT/EP2013/076244

§ 371 Date: Jun. 8, 2015

(30) Foreign Application Priority Data
Dec. 20, 2012 (DE) 10 2012 224 109.4

(51) Int. Cl. G01S 19/13

(52) U.S. Cl. CPC G01S 19/13

(57) ABSTRACT

A device for determining the location of a vehicle, the device having a position-determining device, including; the position-determining device for determining a position indicating the location of the vehicle, a movement-determining device for determining driving dynamics of the vehicle, and a filter device for determining an error in the position of the vehicle on the basis of the driving dynamics, wherein the position-determining device and the movement-determining device are each connected to the filter device via a dedicated line.

### CROSS REFERENCE TO RELATED APPLICATIONS

This application is the U.S. National Phase Application of PCT/EP2013/076244, filed Dec. 11, 2013, which claims priority to German Patent Application No. 10 2012 224 109.4, filed Dec. 20, 2012, the contents of such applications being incorporated by reference herein.

### FIELD OF THE INVENTION

The invention relates to a device for determining the location of a vehicle, and a vehicle comprising said device.

### BACKGROUND OF THE INVENTION

WO 2011/ 098 333 A1, which is incorporated by reference, discloses using in a vehicle various sensor values in order to improve existing sensor values or to generate new sensor values and hence to increase the information that can be acquired.

### SUMMARY OF THE INVENTION

An aspect of the invention improves the use of a plurality of sensor values for increasing information.

According to an aspect of the invention, a device for determining the location of a vehicle having a position-determining unit comprises said position-determining unit for determining a position that locates the vehicle, a movement-determining unit for determining vehicle dynamics of the vehicle, and a filter unit for determining on the basis of the vehicle dynamics an error in the position of the vehicle, wherein the position-determining unit and the movement-determining unit are each connected to the filter unit via a dedicated line.

The defined device is based on the idea that the error determined by the filter unit could be used, for example, to correct the locating position in the filter unit itself or in the position-determining unit. The correction would only be useful, however, if the error is determined within a narrow timeframe of acquiring the vehicle-locating position and the vehicle dynamics of the vehicle, because otherwise the error no longer matches the vehicle-locating position and is hence outdated. The determined error would therefore be valueless.

The defined device is also based on the consideration that it is practical in a standard vehicle architecture to install the position-determining unit, such as a receiver for a global navigation satellite system signal, for instance, referred to below as a GNSS receiver, and the movement-determining unit, such as, for instance, an inertial measurement unit known as an IMU, at two different points because different boundary conditions distort the values to be measured by these units. Thus, for example, a GNSS receiver should be arranged as close as possible to the antenna in order to minimize signal fluctuations in the GNSS signal caused by long cables. In contrast, an IMU should be arranged as close as possible to the center of gravity of the vehicle in order to avoid lever-arm induced errors when acquiring the vehicle dynamics of the vehicle. The data from the two sensors would therefore have to be interchanged in some way, for which purpose a bus system installed anyway in the vehicle, for instance a CAN bus (Controller Area Network bus), would be suitable.

Based on this further consideration, the defined invention recognizes, however, that transmitting the data from the position-determining unit and the movement-determining unit via the bus system could result in non-deterministic transmission latencies that hence cannot be corrected. In the case of the aforementioned CAN bus, these non-deterministic transmission latencies can be as much as 2 ms, which can be increased by jitter by typically up to 2 ms, at most up to 10 ms. The filter unit would hence receive correspondingly outdated data, reducing accordingly the data integrity of the calculated error from the filter unit. If such an outdated error were used to correct the vehicle-locating position or the vehicle dynamics of the vehicle, it could even have the opposite effect and impair the data integrity of the vehicle-locating position or of the vehicle dynamics of the vehicle.

Therefore the present invention proposes accepting a correspondingly higher electronic complexity and connecting the position-determining unit and the movement-determining unit to one another via a dedicated line in order to reduce the aforementioned transmission latencies and hence increase the data integrity at least of the error but preferably also of the vehicle-locating position and/or of the vehicle dynamics of the vehicle. Data integrity shall be understood below to include at least temporal correctness of data, from which data it can be identified whether or not a situation described by the data is already outdated.

In the context of the defined device, the vehicle-dynamics data output by the movement-determining unit shall be understood to mean vehicle acceleration and/or angular-rate data about the main axes. The vehicle-dynamics data output by the movement-determining unit may include here longitudinal accelerations, lateral accelerations, vertical accelerations, yaw rates, roll data and/or pitch data.

In a development of the defined device, the position-determining unit, the movement-determining unit, the filter unit and the dedicated lines are integrated in a common module. This can further reduce the lengths of the dedicated lines between the position-determining unit, the movement-determining unit and the filter unit, and hence propagation delays, thereby further increasing the data integrity of the data from the filter unit.

In a particular development, the common module comprises a common substrate on which are arranged the position-determining unit, the movement-determining unit, the filter unit and the dedicated lines. This can minimize the lengths of the dedicated lines and hence the aforementioned propagation delays, thereby further increasing the data integrity of the data from the filter unit.

In order to further reduce transmission latencies between the individual units in the defined device, in a particularly preferred development, the defined device can comprise a memory which is used jointly by the position-determining unit, the movement-determining unit and the filter unit so that delays during memory access can be minimized.

In another development of the defined device, the position-determining unit is designed to determine the absolute position of the vehicle on the basis of two different position-determining signals having two different frequencies. It is thereby possible to achieve a greater accuracy of the position-determining unit and hence an improved basis for the fusion with the movement-determining unit.

In an additional development of the defined device, the position-determining unit is designed to receive the error from the filter unit, and to correct the locating position of the vehicle on the basis of the error. Such a position-determining unit includes, for example, a receiver for a signal from a deeply coupled global navigation satellite system, known as a deeply coupled GNSS receiver. In this system, the navigation information such as position, velocity and so on is fed back into the deeply coupled GNSS receiver in order to be able to smooth out more effectively variations caused by, for example, Doppler shifts in the input frequencies and so on. Compared with a tightly coupled GNSS receiver, the data from the movement-determining unit is hence used not solely in the filter unit in order to be able to determine the location as accurately as possible, but also in the position-determining unit in order to improve the robustness and sensitivity of the GNSS signal reception. Although the above-mentioned improvements can also be observed when using a tightly coupled GNSS receiver as the position-determining unit in the defined device, in a deeply coupled GNSS receiver an error in the vehicle-locating position is reduced further by feedback into the position-determining unit, which results in higher data integrity. This higher data integrity, however, can only be achieved when time delays in the feedback are sufficiently small and hence transmission latencies are sufficiently low, which is why the defined device can display its full potential for increasing the data integrity in conjunction with a deeply coupled GNSS receiver.

According to a further aspect of the invention, a vehicle comprises one of the defined devices.

In a development, the defined vehicle comprises an antenna for receiving a signal for the position-determining unit, wherein the device is arranged on the antenna. As already mentioned, aforesaid transmission latencies should be minimized. In this regard, the defined development is based on the consideration that the movement-determining unit mainly introduces lever-arm errors into the vehicle-dynamics data when said unit is not arranged in the vehicle center of gravity. Unlike the stochastic transmission latencies in the GNSS signal received via the antenna, however, the lever arms are largely deterministic error sources especially in vehicles having rigid vehicle bodies and can be taken into account in the output of the vehicle-dynamics data. Therefore technically the most sensible arrangement of the movement-determining unit is together with the position-determining unit close to the antenna. But even in vehicles without rigid vehicle bodies it is advantageous to arrange the movement-determining unit at the antenna because the movement-determining unit can be moved synchronously with the antenna when acquiring the vehicle dynamics of the vehicle, and hence it is possible to suppress errors in determining the location of the vehicle that arise from the movement of the antenna with respect to the center of gravity of the vehicle in a vehicle having a non-rigid vehicle body.

In an alternative or additional development, the defined vehicle comprises a further movement-determining unit, which is arranged at a center of gravity of the vehicle. In the case of the aforementioned non-rigid vehicle bodies, the above-mentioned lever-arm error is no longer purely deterministic because the deformation of the vehicle body, which is difficult to detect, affects the vehicle dynamics. By using two movement-determining units, especially in less rigid vehicle bodies, it is possible to combine the above-mentioned advantages in arranging the movement-determining unit close to the antenna with the arrangement of the movement-determining unit close to the center of gravity.

In an additional development, the defined vehicle could comprise particularly advantageously an angular-rate determining unit, which is designed to determine angular rates of the vehicle on the basis of acceleration signals output from the movement-determining units. Two low-cost accelerometers which measure the accelerations of the vehicle in the longitudinal, lateral and vertical directions could thereby be used, for example, for the two movement-determining units instead of two expensive 6-axis IMUs.

### BRIEF DESCRIPTION OF THE DRAWINGS

The above-described properties, features and advantages of this invention, and the way in which they are achieved, are elucidated and explained more clearly by the following description of the exemplary embodiments, which are explained in greater detail in conjunction with the drawings, in which:

FIG. 1 is a block diagram of a vehicle having a fusion sensor, and

FIG. 2 is a block diagram of the fusion sensor of FIG. 1.

In the figures, the same technical elements are denoted by the same reference signs and are described only once.

### DETAILED DESCRIPTION OF THE INVENTION

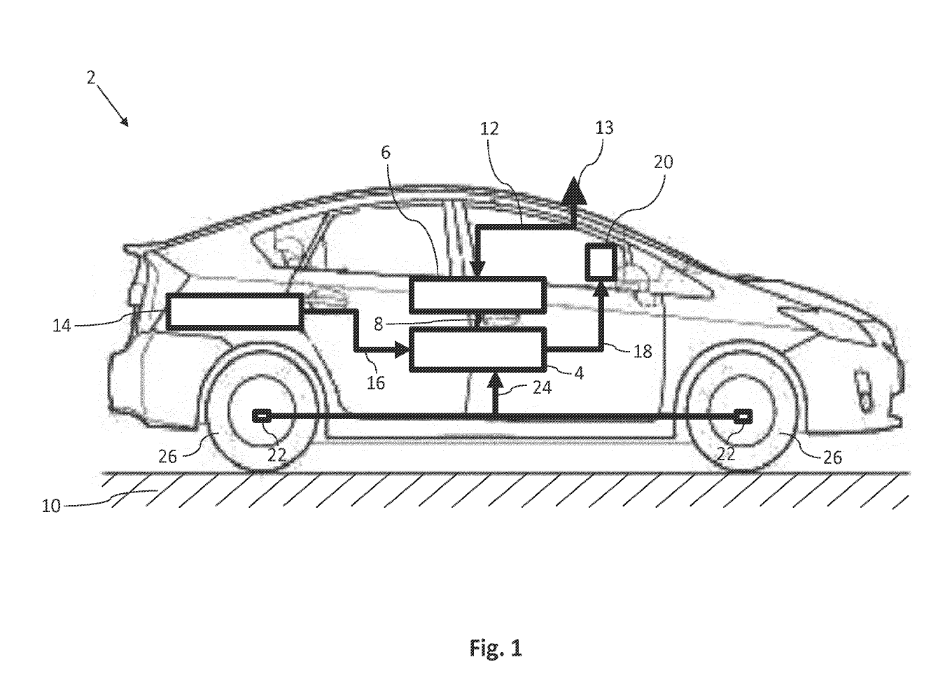

Reference is made to FIG. 1, which shows a block diagram of a vehicle 2 having a fusion sensor 4.

In the present embodiment, the fusion sensor 4 receives position data 8 of the vehicle 2 via a GNSS receiver 6 known per se, which data comprises an absolute position of the vehicle 2 on a road 10, In addition to the absolute position, the position data 8 from the GNSS receiver 6 also comprises a velocity of the vehicle 2. In the present embodiment, the position data 8 from the GNSS receiver 6 is derived in the GNSS receiver 6 from a GNSS signal 12 in a manner known to a person skilled in the art, which signal is received via a GNSS antenna 13 and is hence referred to below as GNSS position data 8. Details of this can be found in the relevant technical literature.

The fusion sensor 4 is designed, in a manner to be described below, to increase the information content of the GNSS position data 8 derived from the GNSS signal 12. This is needed partly because the GNSS signal 12 has a very low signal-to-noise ratio and hence can be very inaccurate, and partly because the GNSS signal 12 is not constantly available.

In the present embodiment, the vehicle 2 comprises for this purpose a movement-determining unit 14, which acquires the vehicle-dynamics data 16 of the vehicle 2. As is known, this data includes a longitudinal acceleration, a lateral acceleration and a vertical acceleration, and a roll rate, a pitch rate and a yaw rate of the vehicle 2. This vehicle-dynamics data 16 is used in the present embodiment to increase the information content of the GNSS position data 8, and, for instance, to specify more accurately the position and velocity of the vehicle 2 on the road 10. The more accurately specified position data 18 can then be used by a navigation device 20 even when the GNSS signal 12 is completely unavailable, for example in a tunnel.

In order to increase the information content of the GNSS position data 8 further, wheel-speed sensors 22 can optionally also be used in the present embodiment, which detect the wheel speeds 24 of the individual wheels 26 of the vehicle 2. Likewise, a steering-angle signal can be used to increase further the information content of the GNSS position data.

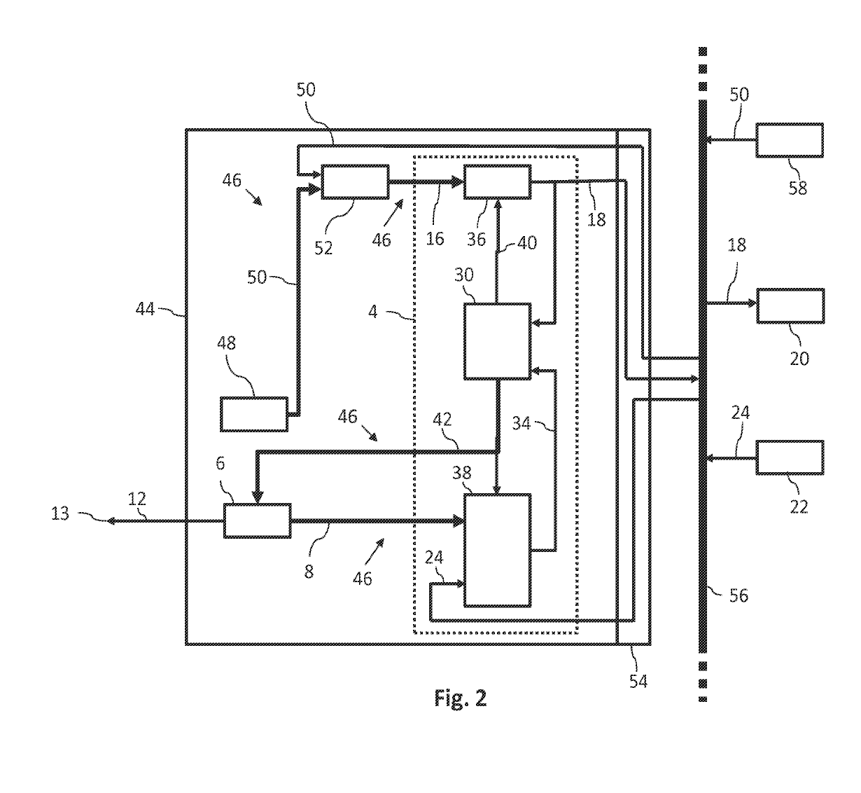

Reference is made to FIG. 2, which shows a block diagram of the fusion sensor 4 from FIG. 1.

The measurement data already mentioned in FIG. 1 is input to the fusion sensor 4. The fusion sensor 4 is intended to output the more accurately specified position data 18. The fundamental idea here is to compare in a filter 30 the information from the GNSS position data 8 with the vehicle-dynamics data 16 from the movement-determining unit 14 and thereby increase a signal-to-noise ratio in the position data 8 from the GNSS receiver 6 or in the vehicle-dynamics data 16 from the movement-determining unit 14. Although the filter can have any design for this purpose, a Kalman filter is the most effective solution to this problem, requiring relatively low processing resources. Therefore the filter 30 shall preferably be a Kalman filter 30 below.

The more accurately specified position data 18 from the vehicle 2 and comparative position data 34 from the vehicle 2 are input to the Kalman filter 30. In the present embodiment, the more accurately specified position data 18 is generated from the vehicle-dynamics data 16 in a strapdown algorithm 36 known, for example, from DE 10 2006 029 148 A1, which is incorporated by reference. This data contains more accurately specified position information about the vehicle but also other position data about the vehicle 2 such as, for example, its velocity, its acceleration and its heading. In contrast, the comparative position data 34 is obtained from a model 38 of the vehicle 2, which model is initially supplied with the GNSS position data 8 from the GNSS receiver 6. Then the comparative position data 34, which contains the same information as the more accurately specified position data 18, is determined in the model 38 from this GNSS position data 8. The more accurately specified position data 18 and the comparative position data 34 differ merely in terms of their values.

The Kalman filter 30 calculates on the basis of the more accurately specified position data 18 and the comparative position data 34 an error budget 40 for the more accurately specified position data 18, and an error budget 42 for the comparative position data 34. An error budget shall be understood below to mean a total error in a signal, which error is composed of various individual errors in the acquisition and transmission of the signal. For the GNSS signal 12 and hence for the GNSS position data 8, the corresponding error budget may be composed of errors from the satellite orbit, from the satellite clock and from residual refraction effects and of errors in the GNSS receiver 6. This error budget would be included in the error budget 42 for the comparative position data 34.

The error budget 40 for the more accurately specified position data 18, and the error budget 42 for the comparative position data 34 are then input respectively to the strapdown algorithm 36 and the model 38 for correcting the more accurately specified position data 18 and the comparative position data 34 respectively. In other words, the more accurately specified position data 18 and the comparative position data 34 are cleaned iteratively of their errors.

In the present embodiment, the fusion sensor 4, the GNSS receiver 6 and components of the position-determining unit 14 (not denoted again by a reference sign in FIG. 2) are arranged in a common fusion module 44, which may be in the form of, for instance, a common housing, a common substrate such as a printed circuit board or even a common circuit on a chip. The fusion module 44 is here are arranged in the vehicle 2 local to the antenna 13.

In the fusion module 44, the GNSS receiver 6 outputs the position data 8 to the fusion sensor 4 via a dedicated line 46, which is indicated by a bold line in FIG. 2.

In addition, the fusion module 44 comprises a first accelerometer unit 48, which is arranged together with the. GNSS receiver 6 local to the antenna 13. The first accelerometer unit 48 measures at the position of the antenna 13 the accelerations 50 of the vehicle 2 in all three spatial directions, and transfers these accelerations via a dedicated line 46 to an inertial calculation unit 52, which in turn outputs the vehicle-dynamics data 16 to the fusion sensor 4 via a dedicated line in a manner still to be described.

The fusion module 44 also comprises a bus interface 54, via which the more accurately specified position data 18 and the wheel speeds 24 can be respectively transmitted to the navigation device 20 and received from the wheel-speed sensors 22 by means of a CAN bus 56.

In the present embodiment, a second accelerometer unit 58 is additionally connected to the CAN bus 56, which unit measures the accelerations 50 of the vehicle 2 at the center of gravity of the vehicle 2, and outputs same via the CAN bus 56 to the inertial calculation unit 52 together with a precise time stamp. The inertial calculation unit 52 knows the distance between the first accelerometer unit 48 and the second accelerometer unit 58 and can therefore calculate on the basis of the measured accelerations 50 of the vehicle at the two positions the angular rates of the vehicle 2, i.e. the rates for yaw, roll and pitch. Hence the two accelerometer units 48, 58 together with the inertial calculation unit 52 replace a conventional inertial measurement unit.

In the present embodiment, the error budget 42, for example for the comparative position data 34, together with the abovementioned error budget for the GNSS signal 12, can optionally be sent back into the GNSS receiver 6 via a dedicated line 46 so that the GNSS receiver 6 can take into account the error budget 42 in order to determine the position data 8 more accurately on the basis of the GNSS signal 12, as is done in a deeply coupled GNSS receiver known per se.

1. A device for determining the location of a vehicle having a position-determining unit, comprising:
said position-determining unit for determining a position that locates the vehicle,
a movement-determining unit for determining vehicle dynamics of the vehicle, and
a filter unit for determining on the basis of the vehicle dynamics an error in the position of the vehicle,
wherein the position-determining unit and the movement-determining unit are each connected to the filter unit via a dedicated line.

2. The device as claimed in claim 1, wherein the position-determining unit, the movement-determining unit, the filter unit and the dedicated lines are integrated in a common module.

3. The device as claimed in claim 2, wherein the common module comprises a common substrate on which are arranged the position-determining unit, the movement-determining unit, the filter unit and the dedicated lines.

4. The device as claimed in claim 1, comprising a memory which is used jointly by the position-determining unit, the movement-determining unit and the filter unit.

5. The device as claimed in claim 1, wherein the position-determining unit is designed to determine the absolute position of the vehicle on the basis of two different position-determining signals having two different frequencies.

6. The device as claimed in claim 1, wherein the position-determining unit is designed to receive the error from the filter unit, and to correct the locating position of the vehicle on the basis of the error.

7. A vehicle comprising a device as claimed in claim 1.

8. The vehicle as claimed in claim 7, comprising an antenna for receiving a signal for the position-determining unit, wherein the device is arranged on the antenna.

9. The vehicle as claimed in claim 7 or 8, comprising a further movement-determining unit, which is arranged at a center of gravity of the vehicle.

10. The vehicle as claimed in claim 9, comprising an angular-rate determining unit, which is designed to determine angular rates of the vehicle on the basis of acceleration signals output from the movement-determining units.

11. The vehicle as claimed in claim 8, comprising a further movement-determining unit, which is arranged at a center of gravity of the vehicle.
